(19) United States
(12) Patent Application Publication
(10) Pub. No.: US 2017/0270258 A1
(43) Pub. Date: Sep. 21, 2017

(54) METHOD AND SYSTEM FOR MANAGING CLEANING OF MEDICAL DEVICES

(71) Applicant: General Electric Company, Schenectady, NY (US)

(72) Inventors: David Wayne Duckert, Wauwatosa, WI (US); Bruce Arnold Friedman, Jasper, GA (US)

(73) Assignee: General Electric Company, Schenectady, NY (US)

(21) Appl. No.: 15/071,788

(22) Filed: Mar. 16, 2016

(51) Int. Cl. G06F 19/00

(52) U.S. Cl. CPC G06F 19/3412

(57) ABSTRACT

A system for managing cleaning of one or more medical devices includes a central computing system having a processor, the central computing system communicatively connected to the one or more medical devices. The system further includes a cleaning mode module executable on a processor of the one or more medical devices to initiate a cleaning event, disable control input function of one or more touch inputs to the medical device, record cleaning event information, end the cleaning event and re-enable the control input function of the one or more touch inputs, and transmit the cleaning event information to the central computing system. The system further includes a cleaning report module executable on the processor of the central computing system to generate a cleaning report from the cleaning event information and store the cleaning report.

### BACKGROUND

This invention relates generally to managing the cleaning of medical devices, and particularly managing cleaning of medical devices having one or more touch inputs.

Hospital acquired infections are a major problem. Cleaning and disinfection of medical equipment is now mandated by the FDA, and each hospital and medical facility may have its own policy for implementation of FDA cleaning requirements.

For example, it is necessary to periodically clean the touch inputs of each medical device, such as according to the standards set by the hospital or medical facility. However, cleaning medical devices with touch inputs, such as touchscreens, keyboards, buttons, touchpads, etc., can be difficult because touching these elements for cleaning can provide unwanted control inputs to the medical device. The touchscreen presents a visual display of buttons or other target areas that indicate to the user where to touch the touchscreen to activate certain features of the associated medical device or to input certain information. Repetitive touching of the touchscreen and/or other touch inputs results in a buildup of oil and dirt on the surface of the touch input, and these touch surfaces can be vectors of infection transmittal if they are not properly cleaned.

### SUMMARY

This Summary is provided to introduce a selection of concepts that are further described hereinbelow in the Detailed Description. This Summary is not intended to identify key or essential features from the claimed subject matter, nor is it intended to be used as an aid in limiting the scope of the claimed subject matter.

In one embodiment, a system for managing cleaning of one or more medical devices includes a central computing system having a processor, the central computing system communicatively connected to the one or more medical devices. The system further includes a cleaning mode module executable on a processor of the one or more medical devices to initiate a cleaning event, disable control input function of one or more touch inputs to the medical device, record cleaning event information, end the cleaning event and re-enable the control input function of the one or more touch inputs, and transmit the cleaning event information to the central computing system. The system further includes a cleaning report module executable on the processor of the central computing system to generate a cleaning report from the cleaning event information and store the cleaning report.

One embodiment of a method of managing cleaning of a medical device includes receiving a user input at a user interface of the medical device to engage a cleaning mode, initiating a cleaning event with a processor, automatically disabling control input function of one or more touch inputs to the medical device, recording cleaning event information with the processor, and ending the cleaning event and automatically re-enabling the control input function of the one or more touch inputs.

Various other features, objects and advantages of the invention will be made apparent from the following description taken together with the drawings.

### BRIEF DESCRIPTION OF THE DRAWINGS

The drawings illustrate the best mode presently contemplated of carrying out the disclosure. In the drawings:

FIG. 1 is a schematic depiction of one embodiment of a system for managing cleaning of one or more medical devices;

FIG. 2A is a schematic depiction of one embodiment of a computing system for a medical device communicatively connected within a system for managing cleaning of medical devices;

FIG. 2B is a schematic depiction of one embodiment of a central computing system within a system for managing cleaning of one or more medical devices;

FIG. 3 depicts an exemplary embodiment of a touchscreen displaying a visual indicator of a predetermined cleaning requirement;

FIG. 4 is a flow chart depicting one embodiment of a method of managing cleaning of a medical device;

FIG. 5 is a flow chart depicting another embodiment of a method of managing cleaning of a medical device; and

FIG. 6 is a flow chart depicting another embodiment of a method of managing cleaning of a medical device.

### DETAILED DESCRIPTION

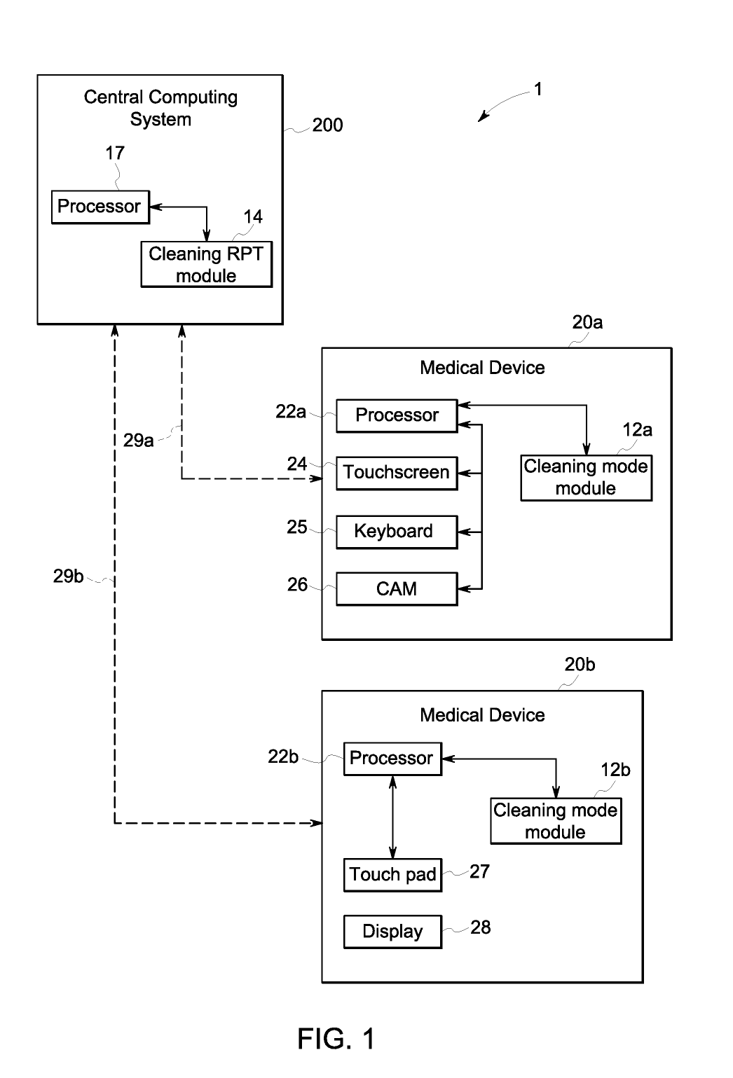

FIG. 1 depicts one embodiment of a system 1 for managing cleaning of one or more medical devices, which in the depicted embodiment are represented as medical devices 20a and 20b. In general, the terms “clean” and “cleaning” as used herein may be interpreted to refer to and include actions related to “disinfection” and “disinfecting.” Each medical device 20a, 20b has a processor 22a, 22b and one or more touch inputs 24-27. Specifically, medical device 20a includes touch inputs being a touchscreen 24, a keyboard 25, and an acquisition module (CAM) 26 for acquiring cardiac signals from a patient. The touchscreen may be any touch-sensitive display screen device configured to allow a user to provide control inputs to the medical device and see visual display outputs from the medical device 20a. The keyboard 25 is generally a device containing a panel of keys that can be used to provide input to the respective medical device 20a, which may be an alphanumeric keyboard or other button panel. For example, the keyboard may include any type of key or pushbutton or membrane switch that can be depressed by a user in order to provide input to the medical device 20a. The CAM 26 may be any device configured to acquire physiological signals from a patient, such as a device configured to record and/or transmit electrical signals sensed by three or more sensors on a patient's chest for recording electrocardiograph (ECG) signals from the patient. In the depicted embodiment, the CAM 26 also includes one or more touch inputs for controlling operation of the device, such as a touch pad of or a touchscreen, that must be cleaned when cleaning the medical device 20a. The second medical device 20b includes a touch pad 27, which may be any panel or device containing one or more touch sensitive areas that may be used to provide input to the medical device 20b, such as in conjunction with a display 28.

Through their research and experimentation in the relevant field, the present inventors have recognized that a method and system are needed for tracking cleaning of medical devices within a healthcare facility. For example, a healthcare facility may set policies regarding cleaning of medical devices, and a system is needed for automatically and objectively tracking compliance with the hospital policy. Tracking of when and how often a device is cleaned enables a hospital facility to review and audit the cleaning practices that are occurring within its facility and to assess whether its cleaning practices are sufficient to avoid transmission of infection.

Moreover, the present inventors have recognized problems with cleaning existing medical devices in that cleaning the touch inputs often inadvertently causes unwanted control input to the medical device. Accordingly, the inventors recognized that the control input function—i.e., the typical operating function where control commands are associated with each of the touch inputs 24-26, 27—of the touch inputs 24-26, 27 needs to be disabled during the cleaning event. Furthermore, they recognized that the touch sensing capabilities of the touch input 24-26, 27 devices may be utilized to track the cleaning of those touch inputs 24-26, 27 as cleaning event information 40, such as by sensing touching of the touch input 24-26, 27 during the cleaning event to track which touch input 24-26, 27 has been cleaned.

The disclosed system 1 and method 60 of managing cleaning of a medical device 20a, 20b may track and record any of numerous types of cleaning event information 40, such as cleaning start time, cleaning end time, cleaning duration, and/or usage of the medical device 20a, 20b between cleaning events or immediately before a cleaning event. Such information may allow determination of compliance with predetermined cleaning requirements 30 , such as cleaning rules or regulations relating to frequency of cleaning—e.g., cleaning medical devices 20a, 20b at predetermined time intervals or after a specific amount of usage. Exemplarily, if a predetermined cleaning requirement 30 is that the medical device 20a, 20b be cleaned after every usage on a patient, then in addition to recording cleaning start time, cleaning event information 40 may further include usage of the medical device 20a, 20b since the last cleaning event. In other words, the cleaning event information 40 includes sufficient information to determine whether the medical device 20a, 20b is actually cleaned after each usage on a patient, and thus whether the predetermined cleaning requirement 30 of cleaning after every usage has been complied with.

Alternatively or additionally, information regarding clinician identification (ID) of the clinician operating the medical device 20a, 20b, and/or department identification of the clinician or patient may also be recorded, which can allow determination of compliance with cleaning requirements by a clinician or across a department. Furthermore, specific information about each cleaning event can be recorded and can provide information regarding the thoroughness and effectiveness of the cleaning and/or compliance with predetermined cleaning requirements 40, such as requirements for how a particular medical device 20a, 20b is to be cleaned. For example, the recordation of cleaning end time and/or cleaning duration can be used to determine whether the medical device 20a, 20b was adequately cleaned, such as whether the cleaning event took place for at least a predetermined amount of time required to adequately clean the particular medical device 20a, 20b.

In another embodiment, the recordation of cleaning event information 40 includes sensing touch information 34 on one or more of the touch inputs 24-26, 27 to determine whether the touch inputs 24-26, 27 have been cleaned. For example, sensing touch information 34 may include sensing whether the respective touch input 24-26, 27 has been touched during a cleaning event. In an embodiment including a touchscreen 24, for example, sensing touch information 34 may include sensing what portions of the touchscreen 24 have been touched during a cleaning event and assessing whether the entire touch-sensitive surface area of the touchscreen 24 has been touched during the cleaning event, which can be associated with the cleaning of that surface of the touchscreen 24.

Each medical device 20a, 20b in the system 1 for managing cleaning may be equipped with a cleaning mode module 12a, 12b executable on a processor 22a, 22b of the medical device 20a, 20b to receive input from a user to engage a cleaning mode and to initiate and manage a cleaning event, including recording cleaning event information 40. The cleaning mode module 12a, 12b is a software module, a set of computer-readable instructions, that gets invoked upon user input 32 to engage the cleaning mode. The cleaning mode module 12a disables the touch inputs 24-26, 27 on or associated with the medical device 20a-20b so that unwanted control input is not provided to the system due to the activity of cleaning the touch inputs. To provide one exemplary embodiment, the one or more touch inputs 24-26, 27 to the medical device may include a button to engage and disengage, or activate and deactivate, a cleaning mode, which disables the normal operating control functions to the medical device so that the touch inputs may be adequately cleaned without inadvertently inputting control instructions or information to the medical device 20a, 20b.

Each medical device 20a, 20b having the cleaning mode module 12a, 12b is communicatively connected to a central computing system 200, which may be any device, network, or system configured to receive cleaning event information 40 from the medical devices 20a and 20b, and to process that cleaning event information 40 in order to generate a cleaning report. In the depicted embodiment, medical devices 20a and 20b communicate with the central computing system 200 via communication links 29a and 29b, respectively. For example, each medical device 20a, 20b may communicate with the central computing system 200 via a radio frequency protocol, which may include a relatively short range transmission protocol such as Bluetooth, Bluetooth Low Energy (BLE), ANT, or ZigBee, or longer range transmission protocols such as on the wireless medical telemetry service (WMTS) spectrum or on a Wi-Fi-compliant wireless local area network (LAN). In still other embodiments, the central computing system 200 may connect physically with each medical device 20a, 20b in order to transfer information there between, including transferring cleaning event information from the medical device 20a, 20b to the central computing system 200 and transferring predetermined cleaning requirements 30 from the central computing system 200 to the medical device 20a, 20b.

The central computing system 200 has a cleaning report module 14, which is a software module comprising computer-readable instructions executable on the processor 17 to receive the cleaning event information 40 from each medical device 20a, 20b and to generate a cleaning report 42 therefrom. For example, the cleaning report 42 may provide a summary of the cleaning event information 40 for all cleaning events from all medical devices 20a, 20b for a period of time, or may provide a subset of cleaning event information 40, such as cleaning events that fail to meet one or more of the predefined cleaning requirements 30. The cleaning report 42 may provide metrics determined based on the cleaning event information 40, such as information regarding compliance with the predetermined cleaning requirements by medical device 20a, 20b, clinician ID, department ID, type of medical device, period of time, etc. Accordingly, the cleaning reports 42 can document and provide information regarding the cleaning activity occurring within a healthcare facility, and to provide a mechanism by which compliance with a health care facilities' cleaning policy can be determined. The set of predetermined cleaning requirements 40 can be stored within the cleaning database 45, for example, and the cleaning report module 14 may analyze the cleaning event information to determine compliance with the one or more predetermined cleaning requirements 40.

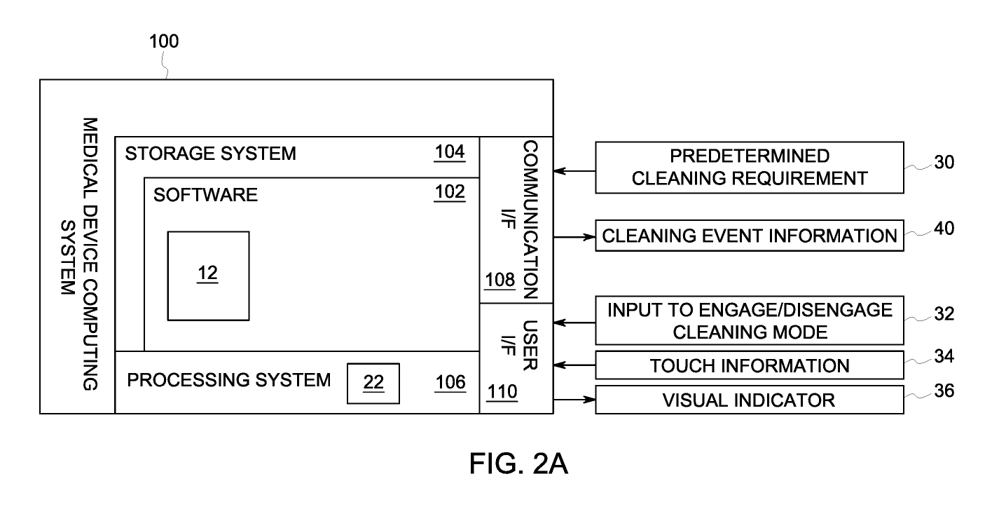

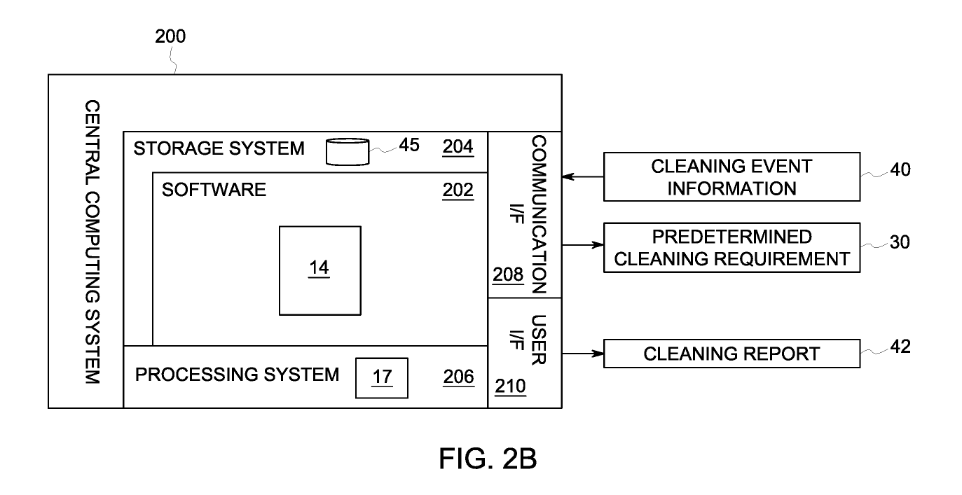

FIGS. 2A and 2B depict exemplary computing systems within and/or implement with the system 1 for managing cleaning. FIG. 2A provides a system diagram of a computing system 100 for a medical device 20a, 20b having software 102 that includes a cleaning mode module 12 having instructions executable to implement a method 60 of managing cleaning as described herein. The computing system 100 includes processing system 106, storage system 104, software 102, communication interface 108, and user interface 110. The processing system 106 loads and executes software 102 from the storage system 104, including the cleaning mode module 12, which is an application within the software 102. The cleaning mode module 12 includes computer-readable instructions that, when executed by the computing system 100 direct the processing system 106 to operate as described herein in further detail. The communication interface 108 includes devices and systems for interfacing with external elements, such as for interfacing with the central computing system 200. For example, the communication interface 108 may include one or more receivers, transmitters, and/or transceivers configured to communicate with the central computing system 200 via communication link 29, which may be established according to any known protocol for radio frequency communication as described above. The communication interface 108 enables to transmission of cleaning event information 40 to the central computing system 200 and the receipt of one or more predetermined cleaning requirements 30 from the central computing system 200. The user interface 110 receives input from a user to engage and/or disengage a cleaning mode, to receive touch information 34 from the touch input during the cleaning event, and to provide a visual indicator 36 of a cleaning requirement and/or compliance therewith.

FIG. 2B depicts a schematic diagram of a central computing system 200 having a cleaning report module 14 and a cleaning management database 45 for storage of cleaning event information. The cleaning management database 45 stores cleaning event information from which the cleaning reports 42 may be generated. Alternatively or additionally, the cleaning management database 45 may also be configured to store cleaning reports, which may allow compilation of information therein and avoid repetitious processing, compiling, or calculation of cleaning event information 40. The central computing system 200 includes processing system 206, storage system 204, software 202, communication interface 208, and user interface 210. The processing system 206 loads and executes software 202 from the storage system 204, including the cleaning report module 14, which is an application within the software 202. The cleaning report module 14 includes computer-readable instructions that, when executed by the central computing system 200, direct the processing system 206, which includes processor 17, to operate as described herein in further detail, including generation of cleaning report 42. The communication interface 208 includes devices and systems enabling communication with the one or more medical devices 20a, 20b within the system 1, which may be transmitters, receivers, and or transceivers configured to communicate via any radio frequency protocol, as described above. The communication interface 208 enables the transmission of the one or more cleaning requirements 30 to the medical device 20a, 20b and receipt of cleaning event information 40 from the medical device 20a, 20b. The user interface 210 is configured to display the cleaning report 42, such as on a display device described hereinbelow.

Although the computing systems 100 and 200 depicted in FIGS. 2A and 2B, respectively, include one software 102, 202, each encapsulating one module 12, 14, it should be understood that one or more software elements having one or more modules may provide the same operation. Similarly, while each Figure depicts a single computing system 100, 200 and processing system 106, 206, it is to be recognized that implementations of such systems can be performed using one or more processors which may be communicatively connected, and such implementations are considered to be within the scope of the description. Moreover, while the computing system 100 of the medical device and the central computing system 200 are depicted as separate computing systems, it is to be recognized that implementations of the methods described herein may be performed using a single computing system having both a cleaning module 12 and a cleaning report module 14, or having a single software module with instructions for executing steps relating to both recordation of cleaning event information 40 and the generation of cleaning reports 42.

The processing systems 106, 206 may comprise a processor 22, 17, respectively, and other circuitry that retrieves and executes software 102, 202 from storage systems 104, 204. Processing system 106, 206 can be implemented with a single processing device 22, 17, as depicted, but can also be distributed across multiple processing devices or sub-systems that cooperate in executing program instructions. Examples of processors 22, 17 include general-purpose central processing units, application-specific processors and logic devices, as well as any other type of processing device, combinations of processing devices, or variations thereof.

The storage systems 104 and 204 can comprise any storage media, or group of storage media, readable by processing system 106, 206, and capable of storing software 102, 202. Each storage system 104, 204 can include volatile and nonvolatile, removable and non-removable media implemented in any method or technology for storing information, such as computer-readable instructions, data structures, program modules, or other data. Each storage system 104, 204 can be implemented as a single storage device, or may be implemented across multiple storage devices or sub-systems. The storage system 204 of the central computing system 200 includes the cleaning management database 45. In one example, software 102, 202 may be stored on a separate storage device than database systems, such as the cleaning management database 45. Likewise, the cleaning management database 45 can be stored, distributed, and/or implemented across one or more storage media or group of storage medias. Similarly, cleaning management database 45 may encompass multiple different sub-databases at different storage locations and/or containing different information which may be stored in different formats. Each storage system 104, 204 may further include additional elements, such as a controller capable of communicating with the processing system 106, 206.

Examples of storage media include random access memory, read only memory, magnetic discs, optical discs, flash memory, virtual memory, and non-virtual memory, magnetic sets, magnetic tape, magnetic disc storage or other magnetic storage devices, or any other medium which can be used to store the desired information and that may be accessed by an instruction execution system, as well as any combination or variation thereof, or any other type of storage medium. Likewise, the storage media may be housed locally with the processing respective system 106, 206, or may be distributed in one or more servers, which may be at multiple locations and networked, such as in cloud computing applications and systems. In some implementations, the storage media can be non-transitory storage media. In some implementations, at least a portion of the storage media may be transitory.

Each user interface 110, 210 may include any one or more of a mouse, keyboard, voice input device, touch input device motion input device for detecting non-touch gestures and other motions by a user, and other comparable input devices and associated processing elements capable of receiving input from a user, such as a clinician. For example, the user interface 110 associated with the one or more medical devices 20a, 20b may include the touch input devices 24-26, 27. Output devices such as video displays or graphical displays can visually display output for a user and may also be included in or associated with one or more of the medical devices 20a, 20b in the system 1 for managing cleaning. Speakers, printers, haptic devices, and other types of output devices may also be included in each user interface 110, 210.

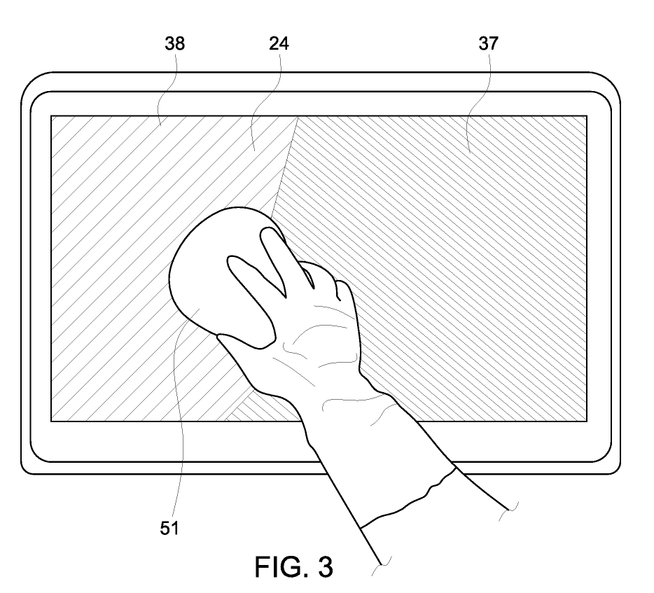

The touchscreen 24 may be used to display cleaning requirements, such as instructions for cleaning and/or to guide the user regarding cleaning of the medical device 20a, 20b, including cleaning the touchscreen 24 or other touch input device. The touchscreen 24 may further be used to provide a visual indicator 36 indicating portions of the touchscreen that have been cleaned. FIG. 3 depicts one embodiment of a touchscreen 24 being cleaned by a user with cleaning cloth 51. The touchscreen displays a first color 37 on portions of the touchscreen 24 that have not yet been cleaned and displays a second color 38 on portions of the touchscreen that have been cleaned. For example, upon initiating a cleaning event and/or disabling the control input function of one or more touch inputs 24-26, the cleaning mode module 12a may control the touchscreen 24 to display a first color, such as a single, solid color across the entire visual and/or touch-sensitive portion of the touchscreen 24. For example, the entire visual display of the touchscreen 24 may display white or a bright color, which may help to illuminate dirt and oil on the touchscreen 24 so that it can be better cleaned by the user. In other embodiments, the first color may be a color other than white and may be a dark color. The cleaning mode module 12a may then process touch information 34 from the touchscreen 24 as the touchscreen 24 is cleaned, sensing what portions of the touchscreen have been touched and turning the portion of the touchscreen that has been touched a second color 38 that is different than the first color 37. Preferably, the second color 38 sufficiently contrasts with the first color 37 so that the user can easily see any portion of the touchscreen 24 that has not been touched with the cleaning cloth 51. For example, in an embodiment where the first color 37 is a light color, the second color 38 may be a dark color. In a similar embodiment, the touchscreen 24 may be frozen upon disabling the control input function of the one or more touch inputs, and the touchscreen 4 may display the second color 28 on the portions of the touchscreen 24 that have been touched. In various embodiments, the color change may occur in real time as the touchscreen 24 is being touched with cleaning cloth 51. In other embodiments, the cleaning mode module 12 may process the touch information 34 and then display or highlight portions of the touchscreen 24 that have not been cleaned after the user has finished wiping the touchscreen 24. In still other embodiments, other visual indication methods may be used to indicate whether or not the touchscreen 24 has been sufficiently cleaned, such as by simply displaying a positive or negative indicator on the touchscreen, such as “clean” or “not clean.”

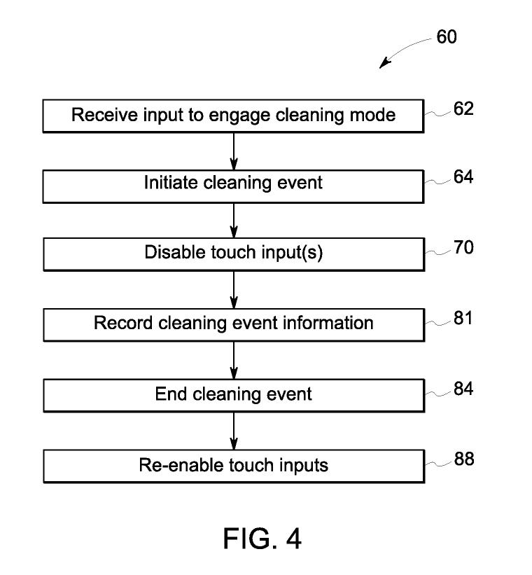

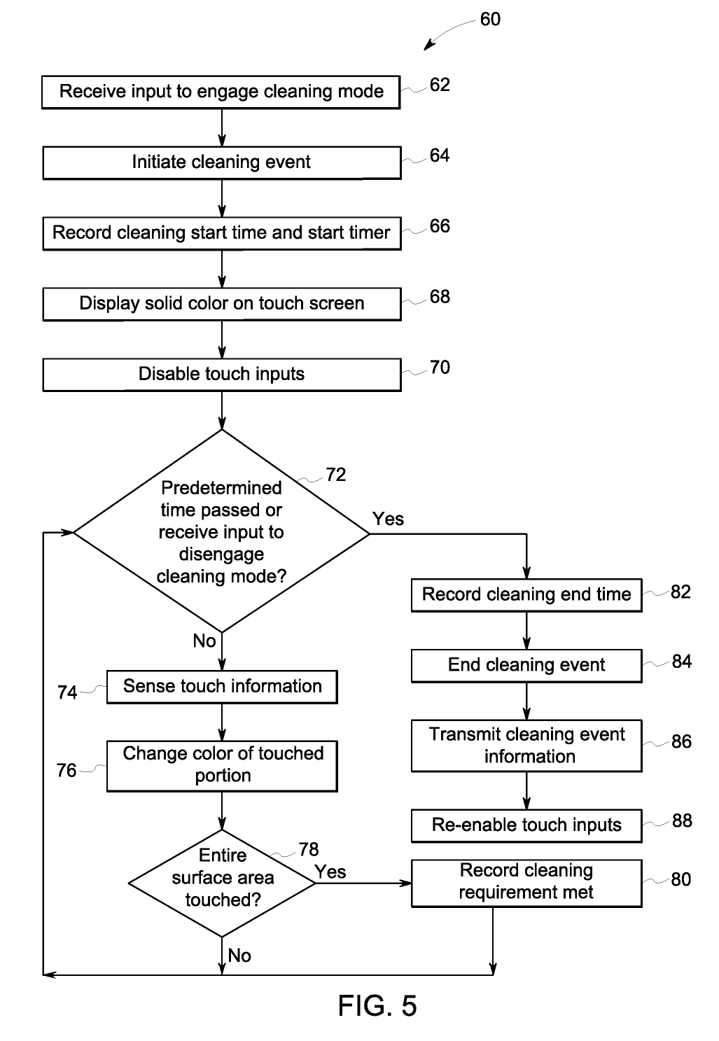

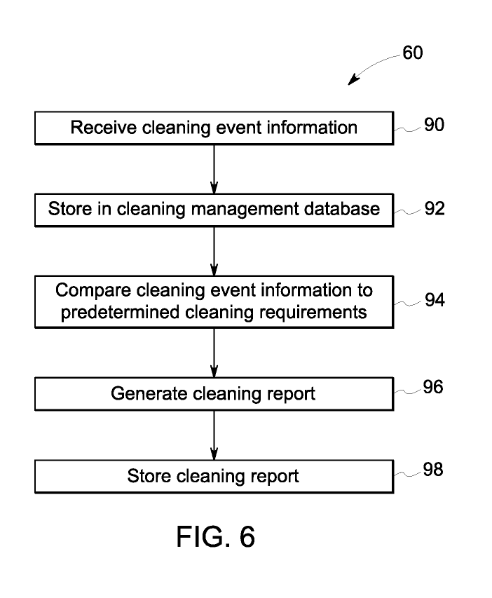

FIGS. 4-6 depict various embodiments of a method 60 of managing cleaning of one or more medical devices 20a, 20b that include touch inputs 24-27. In one embodiment, the method steps depicted in the embodiments of FIGS. 4 and FIGS. 5 may be carried out by executing the cleaning mode module 12 on the processor 22 of a computing system 100 within a medical device 20a, 20b. The method steps depicted in the embodiment of FIG. 6 may be carried out by executing the cleaning report module 14 on processor 17 of the central computing system 200. In other embodiments, various steps depicted in FIGS. 4-6 may be executed by one or the other computing systems 100, 200, or all method steps may be executed by a single computing system. For example, in one embodiment, the computing system 100 of a medical device 20a, 20b may be configured to perform all method steps relating to recording cleaning event information 40 and generating a cleaning report 42, which may be a cleaning report for that particular medical device 20a, 20b, or may be a cleaning report for a set of networked medical devices.

At step 62, input to engage a cleaning mode is received. For example, user input 32 may be received through a user interface 110 of a computing system 100 of a medical device 20a, 20b. A cleaning event is then initiated at step 64, such as by a cleaning mode module 12a, 12b in a medical device 20a, 20b. When the medical device 20a, 20b is in cleaning mode during a cleaning event, the control input function of one or more touch inputs 24-27 may be disabled at step 70 so that unwanted control and/or information input will not be provided to the medical device 20a, 20b during the cleaning event. Cleaning event information is then recorded, such as in memory of the storage system 104 of the computing system 100 within the medical device 20a, 20b. As described above, cleaning event information may include any data regarding the cleaning of the medical device 20a, 20b, including but not limited to a cleaning start and/or end time, a cleaning duration, a clinician ID, a department ID, a number of patient uses between cleanings, or information about steps carried out during the cleaning event and whether one or more predetermined cleaning requirements have been met. At step 84 the cleaning event is ended. For example, the cleaning event may be ended after a predetermined amount of time following initiation of the cleaning event, or the cleaning event may be ended in response to input 32 from a user to disengage the cleaning mode. Once the cleaning event is ended, the touch input control functions of the touch input devices 24-26, 27 of the relevant medical device 20a, 20b being cleaned are re-enabled at step 88.

FIG. 5 depicts another embodiment of a method 60 of managing cleaning of one or more medical devices 20a, 20b. Input 32 to engage a cleaning mode is received at step 62, and a cleaning event is initiated at step 64. At step 66, cleaning start time is recorded as the time that the cleaning event was initiated and a timer is started to record the duration of the cleaning event. The control input function of the relevant touch inputs 24-26, 27 are disabled, as represented at step 70. In embodiments of medical devices 20a, 20b having a touchscreen 24, the touchscreen 24 may be made to display a single, solid color at step 68. The solid color may better illuminate dirty areas for the touchscreen 24, and may also indicate to the user that the cleaning mode has been engaged and the control input function of the touchscreen 24 is disabled. Alternatively or additionally, cleaning instructions, cleaning requirements, or other cleaning-related information may be displayed on the touchscreen. The cleaning mode module 12 determines at step 72 whether a pre-determined amount of time has passed since initiating the cleaning event and/or whether input 32 has been received from the user to disengage the cleaning mode. For example, the cleaning mode module 12 may monitor the timer started at step 66, and the relevant touch inputs 24-26, 27 may be disabled for a predetermined amount of time that is appropriate for cleaning the respective medical device 20a, 20b. Alternatively or additionally, the cleaning mode may continue with the relevant touch inputs 24-26, 27 disabled until input 32 is received from the user to disengage the cleaning mode. For example, the control input function of the touch input element used to engage to cleaning mode at step 62 may be maintained while the medical device 20a, 20b is in cleaning mode, and thus the same input element may be used to both engage and disengage the cleaning mode. In another embodiment, the user input 32 to disengage the cleaning mode may be a unique touch pattern, such as by the user simultaneously touch two separate locations on the touchscreen 24 that are sufficiently spaced apart such that they could not accidentally be touched simultaneously while cleaning the touchscreen 24. For example, the unique touch input to disengage the cleaning mode may be touching two diagonally opposite corners of the touchscreen 24 simultaneously for a predetermined amount of time.

If the predetermined amount of time has not passed since initiating the cleaning event and/or no input 32 has been received to disengage the cleaning mode, then the cleaning event continues and further cleaning event information is recorded. For example, touch information 34 may be sensed at step 74, and such touch information 34 may be interpreted as an indication that the respective touch input 24-27 is being cleaned. If the touchscreen 24 is being touched, the touched portion may be changed to display a second color, indicating that the touched portion of the touchscreen 24 has been cleaned. The cleaning mode module 12 may determine at step 78 whether the entire surface area of the touchscreen 24 has been touched. If the entire surface area has been touched, than the cleaning mode module 12 may record that information as part of the cleaning event information 40, such as by recording that a predetermined cleaning requirement 30 of cleaning the entire touchscreen 24 has been met. Alternatively or additionally, the cleaning mode module 12 may further determine whether all touch inputs 24-26, 27 of the respective medical device 20a, 20b have been touched, and thus whether each of the touch inputs 24-26, 27 has been cleaned. The cleaning mode module 12 may track which touch inputs have been cleaned and such information may be stored as cleaning event information 40.

If at step 72 the predetermined amount of time has passed since initiating the cleaning event and/or input 32 is received to disengage the cleaning mode, then the cleaning end time is recorded at step 82 and the cleaning event is ended at step 84. At step 86 the cleaning event information is transmitted, such as via the communication link 29a, 29b to the central computing system 200. The touch inputs are re-enabled at step 88, which may occur prior to, during, or after transmission of the cleaning event information at step 86. In various embodiments, the cleaning event information may be processed by the cleaning mode module 12 and/or the cleaning report module 14 to determine compliance with predetermined cleaning requirements 30. Such processing may be executed partially or entirely by either the cleaning mode module 12 or the cleaning report module 14. In embodiments where such processing of cleaning event information 40 is executed by the cleaning mode module 12 within the computing system 100 of the medical device 20a, 20b, the processed information may also be transmitted at step 86 along with the cleaning event information 40 to the central computing system 200.

One or more predetermined cleaning requirements 30 may be transmitted from the central computing system 200 to the computing system 100 of the medical device 20a, 20b. The computing system 100 may then utilize the predetermined cleaning requirement(s) 30 as a basis for gathering cleaning event information 40, such as to determine what cleaning event information 40 should be gathered and/or how such cleaning event information 40 should be processed and presented to the central computing system 200. To provide an explanatory example, the central computing system 200 may transmit predetermined cleaning requirements 30 to the computing system 100 of a medical device 20a requiring cleaning of the touchscreen 24, keyboard 25, and CAM 26. In such an embodiment, the cleaning mode module 12 would record the touch information 34 from each of those touch inputs 24-26 to determine and record whether the predetermined cleaning requirement 30 of cleaning touch inputs 24-26 has been satisfied. The satisfaction or non-satisfaction of that cleaning requirement would be part of the cleaning event information 40 recorded by the computing system 100 and transmitted to the central computing system 200.

In various embodiments, step 86 of transmitting the cleaning event information 40 may be executed after completion of each cleaning event. In other embodiments, the cleaning event information 40 may be collected and stored within the storage system 104 of the computing system 100, and step 86 of transmitting the cleaning event information may be executed at a predefined interval, such as every 12 or 24 hours. For example, the system may be configured to transmit the cleaning event information 40 at night when a medical device 20a, 20b is not in use. In other embodiments, the system, such as directed by the cleaning mode module 12, may be configured to transmit the cleaning event information 40 at a convenient time, such as when the respective medical device 20a, 20b is within range of a communication interface 208 for the central computing system 200 and/or when the respective medical device 20a, 20b is not in use.

In the embodiment of FIG. 6, the method 60 of managing cleaning includes step 90-96, which may be executed by the cleaning report module 14. At step 90, the cleaning event information 40 is received at the central computing system 200, such as through communication interface 208. The cleaning event information is stored in the cleaning management database 45. The cleaning event information is compared to the predetermined cleaning requirements at step 94. For example, the cleaning report module 14 may process the cleaning event information 40 to determine whether one or more predetermined cleaning requirements have been met. The predetermined cleaning requirements may be specific to the respective medical device 20a, 20b, or type of medical device, from which the cleaning event information 40 was recorded, or it may be general cleaning requirements for all medical devices in a health care facility. The cleaning report is then generated at step 96 based on the cleaning event information and the processing thereof. For example, the cleaning report may provide information regarding compliance, or lack thereof, with cleaning requirements. For example, the cleaning report may provide general information regarding overall compliance with the predetermined cleaning requirements, or may provide compliance information specific to a particular clinician, department, shift, hospital facility, etc. Alternatively or additionally, the cleaning report may provide information regarding a particular cleaning event, or all cleaning events for a particular medical device 20a, 20b. For example, the cleaning report 42 may be presented on the user interface 210 of the central computing system 200 and may be configured to provide the cleaning event information from one or more medical devices 20a, 20b and regarding one or more cleaning events.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A system for managing cleaning of one or more medical devices, the system comprising:
a central computing system having a processor, the central computing system communicatively connected to the one or more medical devices;
a cleaning mode module executable on a processor of the one more medical devices to:
initiate a cleaning event;
disable control input function of one or more touch inputs to the medical device;
record cleaning event information;
end the cleaning event and re-enable the control input function of the one or more touch inputs;
transmit the cleaning event information to the central computing system;
a cleaning report module executable on the processor of the central computing system to:
generate a cleaning report from the cleaning event information; and
store the cleaning report.

2. The system of claim 1, wherein the cleaning event information includes at least one of a device identification number, a cleaning start time, a cleaning end time, a cleaning duration, a clinician ID, a department ID, a number of patient uses between cleanings, and touch information from one or more of the touch inputs.

3. The system of claim 2, wherein the cleaning mode module is further executable on the processor of one or more of the medical devices to determine whether a predetermined cleaning requirement has been met, and the cleaning event information includes an indication of whether the predetermined cleaning requirement was met during the cleaning event.

4. The system of claim 3, wherein the predetermined cleaning requirement is a minimum frequency for cleaning the respective medical device.

5. The system of claim 3, wherein the one or more touch inputs includes a touchscreen and the cleaning mode module is further executable on the processor to:
track portions of the touchscreen touched during the cleaning event;
determine whether the predetermined cleaning requirement is met based on the portions of the touchscreen touched; and
provide a visual indicator on the touchscreen indicating whether a predetermined cleaning requirement has been met.

6. The system of claim 5, wherein the visual indicator includes displaying the touched portions of the touchscreen in a different color than portions of the touchscreen that have not been touched.

7. The system of claim 1, wherein the cleaning event is ended after receiving input to disengage the cleaning mode or after a predetermined amount of time following receipt of the input to engage the cleaning mode.

8. The system of claim 1, wherein the one or more touch inputs includes a touchscreen and the cleaning mode module is further executable on the processor to indicate one or more predetermined cleaning requirements on the touchscreen.

9. A method of managing cleaning of a medical device, the method comprising:
receiving a user input at a user interface of the medical device to engage a cleaning mode;
initiating a cleaning event with a processor;
automatically disabling control input function of one or more touch inputs to the medical device;
recording cleaning event information with the processor; and
ending the cleaning event and automatically re-enabling the control input function of the one or more touch inputs.

10. The method of claim 9, wherein the step of recording cleaning event information includes storing at least one of a cleaning start time, a cleaning end time, a cleaning duration, a clinician identification, a department identification, a number of uses between cleanings in a storage system of the medical device, and touch information from one or more of the touch inputs.

11. The method of claim 10, further comprising:
transmitting the cleaning event information for each cleaning event to a central computing system;
generating a cleaning report from the cleaning event information using a processor of the central computing system; and
storing the cleaning report in a storage system of the central computing system.

12. The method of claim 11, wherein the step of transmitting the cleaning event information is executed after each cleaning event.

13. The method of claim 12, wherein the step of transmitting the cleaning event information is executed at a predefined interval.

14. The method of claim 9, wherein the one or more touch inputs include a touchscreen, and further comprising:
tracking the cleaning of the touchscreen; and
determining whether one or more predetermined cleaning requirements have been met.

15. The method of claim 14, wherein the cleaning event information includes whether the one or more predetermined cleaning requirements were met.

16. The method of claim 14, wherein the step of tracking the cleaning includes sensing touch information on the touchscreen during the cleaning event, and wherein the predetermined cleaning requirement is that the entire touchscreen is touched during the cleaning event.

17. The method of claim 14, wherein the step of tracking the cleaning includes determining the length of time since initiating the cleaning event, and the step of determining whether a predetermined cleaning requirement has been met includes determining whether the length of time is at least a threshold length of time.

18. The method of claim 14, further comprising displaying a visual indicator on the touchscreen to indicate portions of the touchscreen that have been cleaned.

19. The method of claim 18, further comprising displaying first color on the touchscreen upon disabling the control input function of the one or more touch inputs on the touchscreen, sensing a portion of the touchscreen that has been touched, and turning the portion of the touchscreen that has been touched a second color.

20. The method of claim 9, wherein the step of ending the cleaning event is executed after receiving user input to disengage the cleaning mode or after a predetermined amount of time following initiating the cleaning event.
